(19) United States
(12) Patent Application Publication
(10) Pub. No.: US 2013/0082065 A1
(43) Pub. Date: Apr. 4, 2013

(54) STACKABLE GLASS CONTAINER

(71) Applicants: Vignesh Danabalan, San Jose, CA (US); James Dondero, Millville, NJ (US); William Pierson Hart, Cornelius, NC (US); Michael A. Zarkis, Huntersville, NC (US)

(72) Inventors: Vignesh Danabalan, San Jose, CA (US); James Dondero, Millville, NJ (US); William Pierson Hart, Cornelius, NC (US); Michael A. Zarkis, Huntersville, NC (US)

(73) Assignee: Rubbermaid Incorporated, Huntersville, NC (US)

(21) Appl. No.: 13/252,550

(22) Filed: Oct. 4, 2011

(51) Int. Cl. B65D 1/10; C03B 19/00; C03B 40/02; B65D 1/40

(52) U.S. Cl. 220/602; 220/608; 220/628; 65/84; 65/24

(57) ABSTRACT

A glass container system comprises a glass container comprising a base defining a bottom of the container and a sidewall formed integrally with the base to define an interior space. A protuberance is formed integrally with the base where the protuberance extending beyond a side wall of the base. A lid is dimensioned such that the protuberance engages the lid such that the lid may be releasably secured to the base. A glass container prepared by a process comprising the steps of providing a mold defining a container having a base at a bottom of the mold cavity where the mold cavity comprises an undercut portion that defines a recess in the mold cavity; introducing molten glass to the mold; cooling the glass to cause the glass to shrink a sufficient amount that the protuberance recedes from the recess; and removing the container from the mold in a linear direction.

### BACKGROUND

The invention relates to storage containers such as are commonly used for food storage where the storage container comprises a container such as a plastic bowl or dish for retaining the stored product and a matching plastic cover that snap fits onto the container to create a liquid and/or air tight seal. The containers typically come in a variety of sizes to give the user a choice in the size of container used based on the size of the product being stored. One issue with such containers is the difficulty for the user in storing the containers and lids such that the user may easily locate a desired container and the matching lid. One such system is the Easy Find Lids system sold by Newell Rubbermaid Inc.

### SUMMARY

A glass container system comprises a glass container and lid. The glass container comprises a base that defines a bottom of the container and a sidewall formed integrally with the base to define an interior space. A protuberance is formed integrally with the base where the protuberance extends beyond a side wall of the base. The lid is dimensioned such that the protuberance engages the lid such that the lid may be releasably secured to the base.

The protuberance may extend beyond the side wall of the base less than 1 mm and approximately 0.25 mm. The glass container may comprise a plurality of protuberances. The plurality of protuberances may be spaced about the base. The system may further comprise a second glass container where the second glass container may be dimensioned to nest in the glass container. The lid may comprise a lip where the lip is releasbly engageable with the protuberance such that the lid may be releasably secured to the base.

A glass container made by a process comprising the steps of providing a mold having a mold cavity defining a container having a base at a bottom of the mold cavity where the mold cavity comprises an undercut portion that defines a recess in the mold cavity; introducing molten glass to the mold such that the glass fills the recess of the undercut portion to create a protuberance on the base; cooling the glass to cause the glass to shrink a sufficient amount that the protuberance withdraws from the recess; and removing the container from the mold in a linear upward direction.

The process may further comprise the step of lubricating the mold cavity before each step of introducing molten glass. The process may further comprise the step of flame treating the container without distorting the protuberance. The step of cooling may comprise running coolant over the mold in the area adjacent to the base and recess. The coolant may comprise air. The step of cooling may comprise adequately running coolant over the mold. The process may further comprise the step of tempering the glass.

### BRIEF DESCRIPTION OF THE DRAWINGS

FIG. 1 is a side view of an embodiment of the container of the invention.

FIG. 2 is a top view of the embodiment of the container of FIG. 1.

FIG. 3 is a section view of the container of FIG. 1 connected to a lid.

FIG. 4 is a perspective view of the section view of FIG. 3.

FIG. 5 is a section view of an embodiment of the lid of the invention.

FIG. 6 is a detailed view of the lid of FIG. 5.

FIGS. 7 through 10 are detailed views similar to FIG. 5 showing alternate embodiments of the lid.

FIG. 11 is a section view of the mold and container illustrating a method of making the container.

FIG. 12 is a detailed view showing a portion of the container in the mold.

FIGS. 13 and 14 are section views of the mold illustrating manufacturing steps of the container.

FIG. 15 is a schematic view showing the manufacturing process for the container of the invention.

FIG. 16 is a block diagram illustrating an embodiment of a method of making the container.

FIG. 17 is a perspective view showing a plurality and containers in a stacked storage arrangement.

### DETAILED DESCRIPTION OF PREFERRED EMBODIMENT OF THE INVENTION

The following detailed description refers to the accompanying drawings, which illustrate specific embodiments of the invention. Other embodiments having different structures and operation do not depart from the scope of the present invention. Like reference numbers refer to like structures throughout.

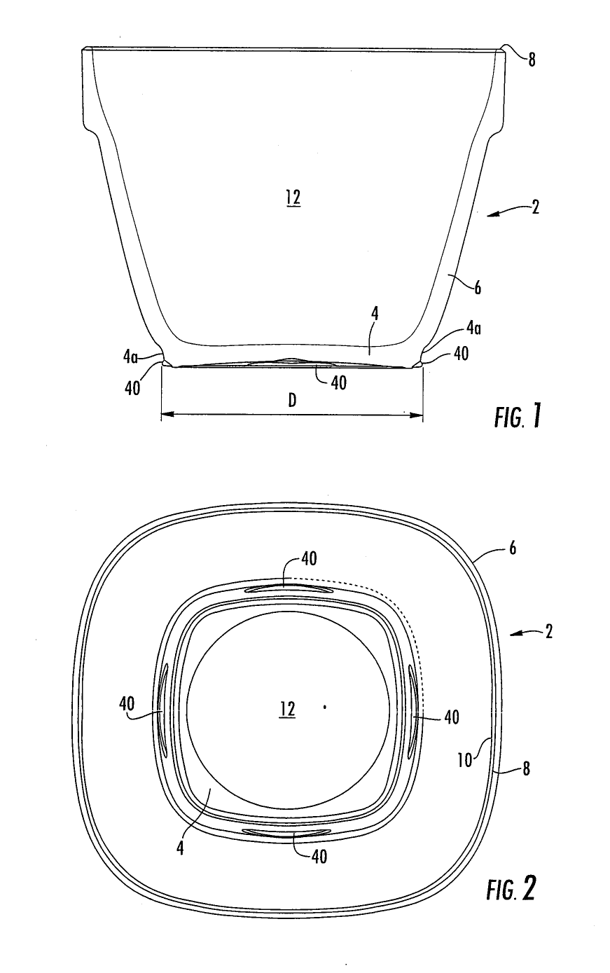

Referring to FIGS. 1 through 4, the container system of the invention comprises a container 2 such as a dish, bowl or the like having a base 4 and an upwardly extending wall 6 that terminates in a top edge 8 that defines an open upwardly extending mouth 10. Mouth 10 allows access to the interior 12 of storage compartment 2 such that a user can store a product in the container 2. The container 2 has a relatively thin wall structure and is made of molded glass. In the illustrated embodiment the container 2 is transparent although the container may be made opaque such as of colored glass. The container 2 may be made in a variety of sizes where like size or smaller size containers may nest inside of the larger size containers to provide convenient space-saving storage as shown in FIG. 17.

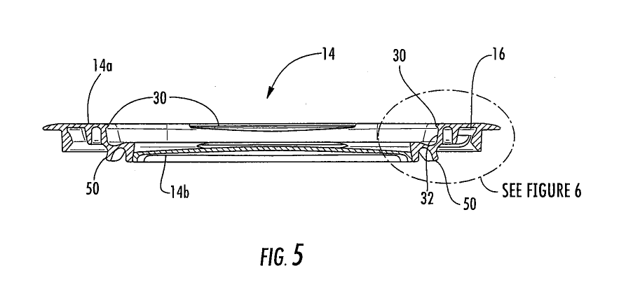

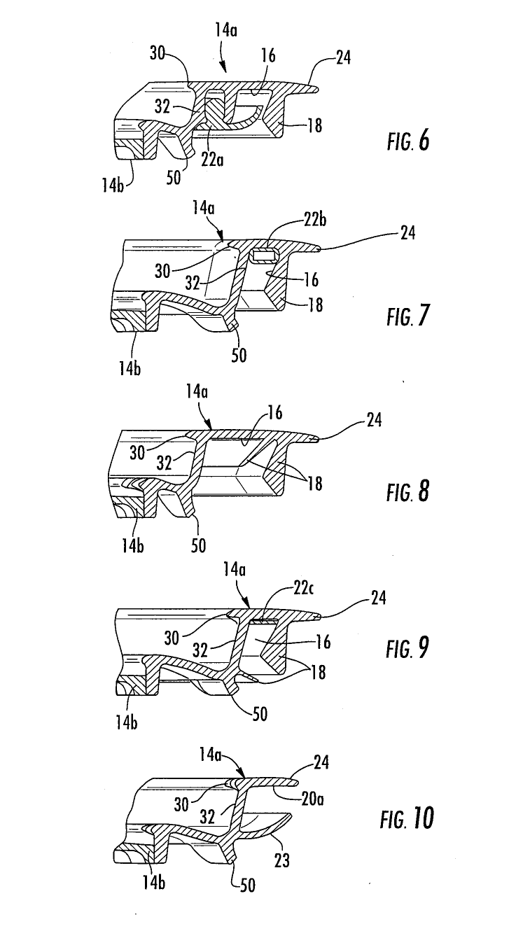

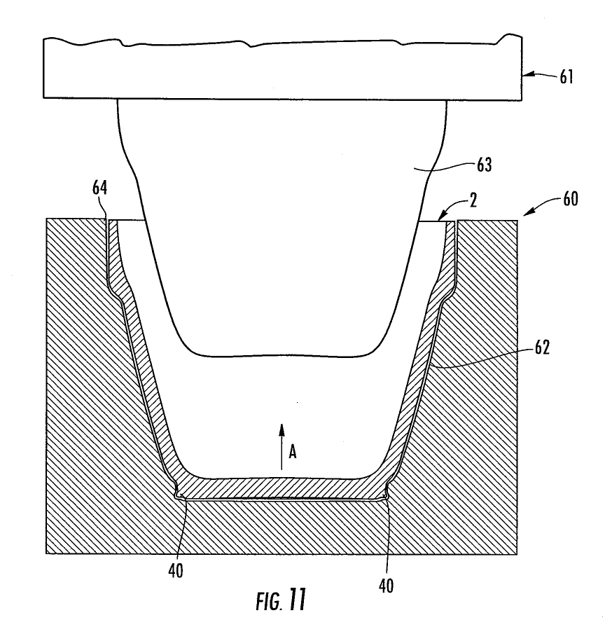

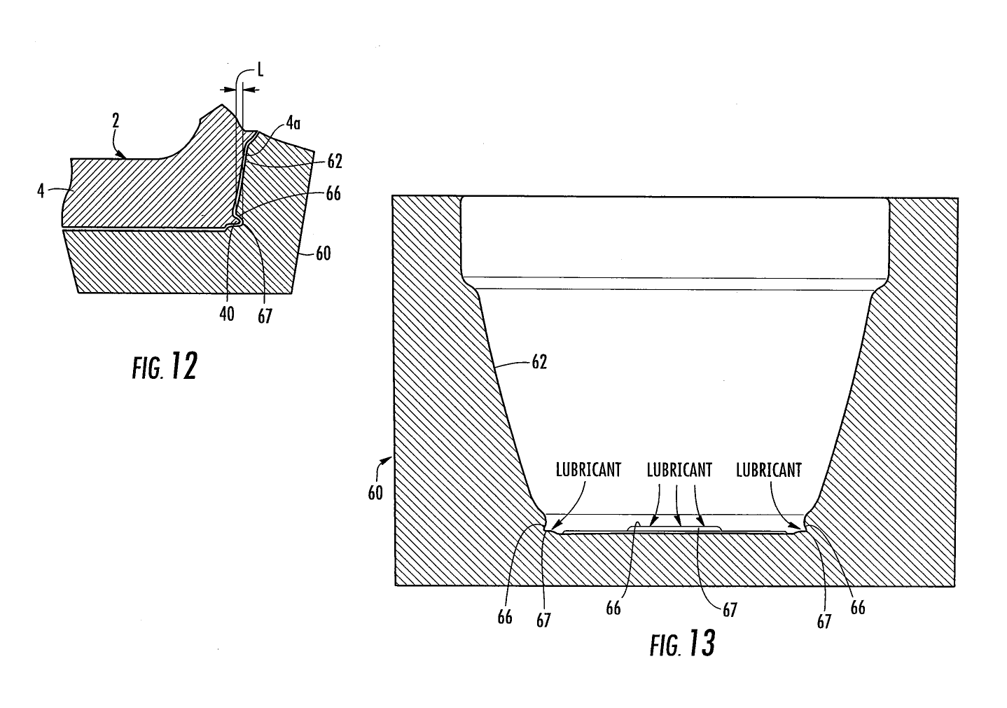

Referring to FIGS. 3 through 10, the lid 14 is made of molded plastic rim portion 14a that may be secured to a transparent rigid center portion 14b. The rim portion 14a is flexible such that it can be snap fit over the top edge 8 of the container 2 to close and seal the container. FIG. 6 shows a more detailed view of the lid of FIG. 5 and FIGS. 7 through 10 are views similar to FIG. 6 of alternate embodiments of the lid. The rim portion 14a comprises a downwardly facing channel 16 that is coextensive with the top edge 8 of container 2 such that the top edge 8 is received in channel 16 when the lid 14 is secured to the mating sized container 2. The channel 16 may be formed with integral flexible gaskets 18 that engage the side wall 6 adjacent to edge 8 to form a liquid/air tight seal between the lid 14 and the container 2. The lid 14 may also be formed with a separate gasket 22a, 22b and 22c as shown in FIGS. 6, 7 and 9, respectively, to engage the side wall 6 of the container 2. FIG. 10 shows a detailed view of an embodiment of the lid where the channel 20a opens to the side rather than downwardly and an integral flexible gasket 23 abuts the inside of wall 6 to create the seal. An edge portion 24 of rim portion 14a extends outwardly from the channel 16 beyond side wall 6 that may be manipulated by a user to deform the lid to allow the lid 14 to be secured to and removed from the container 2. The rigid center portion 14b of the lid 14 may be made of tempered glass that is molded into the plastic rim portion 14a or the center portion 14b may be secured to the rim portion 14a after the rim portion is made by adhesive, mechanical fastener or the like. The transparent center portion 14b allows the user to view the interior 12 of the container through the lid 14.

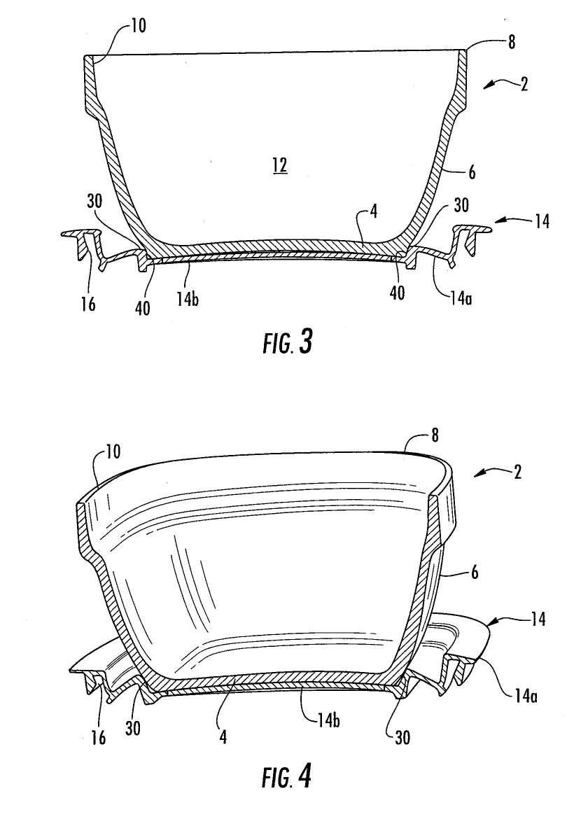

The top of the lid 14 is provided with an inwardly facing lip or series of lips 30 that are engaged by the base 4 of the container 2 such that the base 4 of the container 2 may be secured to the top of the lid 14. By securing the base 4 of the container 2 to the lid 14 the user can store a lid with the like sized container. The lip 30 is formed as part of the molded plastic rim portion 14a on an upwardly extending annular flange 32. The annular flange 32 extends above the top surface of the lid such that the lip 30 is spaced from the top surface of the lid a sufficient distance to receive the base 4 of the container 2. A protuberance or series of protuberances 40 formed on the base 4 (FIGS. 1 and 2) engage the lips 30 to secure the container 2 to the lid 14. Because the flange 32 and lips 30 are formed of molded plastic and are relatively flexible the lid can be deformed to engage and release the base 4 of container 2.

The lid 14 is are also provided with an outwardly facing protuberance or a series of lips 50 formed on the bottom of the rim portion 14a that are releasably engageable with the lips 30 such that the lids may be secured to one another as well as to the base 4 of container 2. The lips 50 are formed at the bottom side of the rim portion 14a and are located such that the lips 50 are disposed opposite to the lips 30 when one lid 14 is placed on top of another lid 14. The lips 50 and lips 30 are both made of molded plastic and are deformable such that both elements can deform to releasably engage one another. To store the containers 2 and lids 14, the containers may be nested inside of one another with the base of the outermost container 2′ secured to a first lid 14′ and the remaining lids 14″ secured to one another and to the first lid as shown in FIG. 17. Each lid may also be separately attached to the bottom of a matching container.

Referring to FIGS. 1 through 4, the base 4 of the glass container 2 is formed with a protuberance or series of protuberances 40 that are dimensioned and located to engage the lips 30 on the top of the lid 14 to secure the lid 14 to the bottom of the container 2. In the illustrated embodiment the base 4 and the side wall 6 of the container 2 have a rectilinear shape such that one protuberance 40 is formed along each side of the base 4. The base 4 may have other configurations such as circular where a series of protuberances 40 are spaced about the periphery of the base. The protuberance may also be formed as a single protuberance that extends about the entire periphery of the base 4.

In order to be able to engage the lips 30 the protuberances 40 must extend beyond the wall portion 4a of the base 4 a predetermined distance to provide sufficient surface area against which the lips 30 can bear. In one embodiment the protuberance 40 extends beyond the wall portion 4a less than 1 mm and approximately 0.25 mm. The extent the protuberance 40 extends beyond the wall 4a is limited by the manufacturing tolerances associated with molding a glass article having an undercut portion as described herein. The container system described herein provides a glass container having undercut protuberances to be used with a deformable lid such that the lid may be releasably attached to the base 4 of the glass container using the protuberances 40.

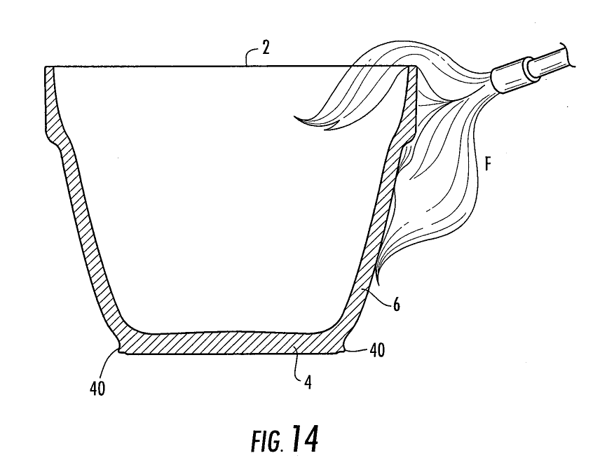

Referring to FIG. 11 a glass container 2 is shown in a mold 60 where the mold comprises an interior wall 62 that defines a mold cavity and forms the shape of the exterior surface of container 2. A plunger 61 has an exterior wall 63 that forms the shape of the interior surface of container 2. The plunger 61 is movable between a first extended position where it is positioned inside of the mold 60 and completes the mold cavity with the mold 60 and a second retracted position where it is removed from the mold 60 to allow molten glass to be deposited in the mold 60 and to allow the molded article to be removed from the mold. The plunger 61 moves in a linear direction relative to the mold between the first and second positions. The plunger 61 also forces or jams the molten glass into the mold cavity to completely fill the mold cavity as it moves between the retracted position and the extended position.

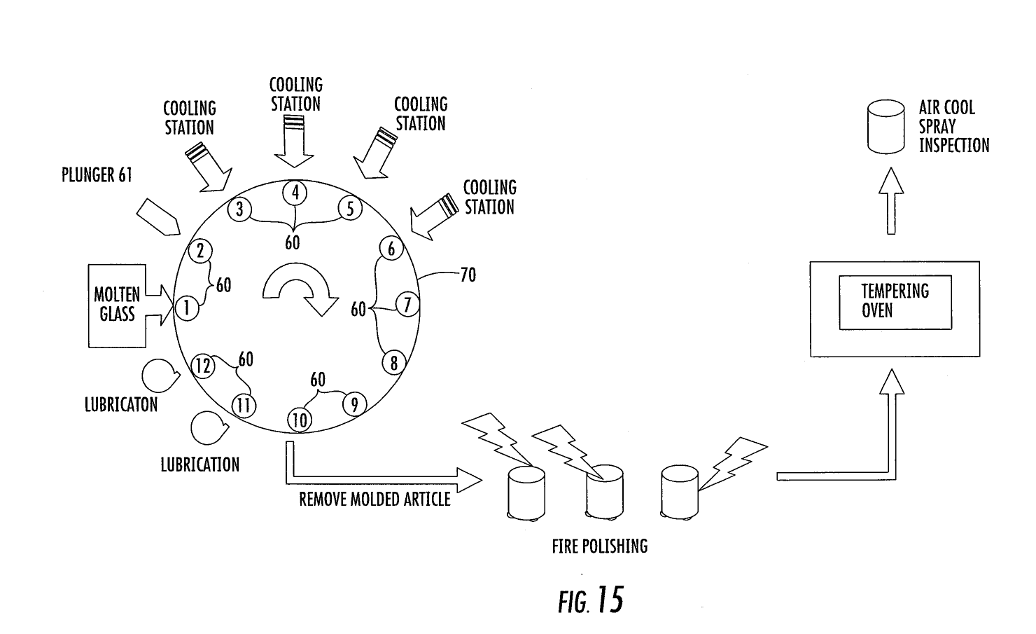

It is to be understood that in glass molding operations the mold 60 and plunger 61 are one-piece structures. The article is removed from the mold by retracting the plunger 61 from the mold 60. The mold 60 is not otherwise disassembled to remove the molded glass article from the mold. The molded glass article 2 is removed in an upward linear fashion from the mold 60 through opening 64 as represented by arrow A. One problem with a molded glass article is that any protuberance formed near the bottom of a molded glass article or formed in a position where the protrusion extends beyond the portion of the article located above the protuberance in the mold cannot be easily removed from the mold 60 because the molded glass protuberance will tend to strike the undercut area of the mold causing the glass article to fracture or chip. Referring to FIG. 12 the protuberance 40 is formed by creating an undercut area 66 in the side wall 62 of the mold 60. The undercut area 66 is created by a recess 67 formed in the wall 62. During molding of the article the glass is forced into the recess 67 to create the protuberance 40 where the protuberance 40 extends beyond the wall 4a of the base. As a result, the protuberance 40 will tend to strike the undercut area 66 of the mold when the molded article is removed from the mold 60 resulting in damage to the glass article such as chipping or fracture. Moreover, such breakage may interrupt the molding operation because any small pieces of glass left in the mold must be completely removed from the mold prior to making the next article.

In order to avoid breaking the article yet still provide a glass container 2 that has protuberances 40 on the base 4, the manufacturing process of the invention has been developed. FIG. 15 illustrates an embodiment of a manufacturing process of the invention and shows a rotatable table 70 having twelve stations, Stations 1-12, where each station comprises a mold 60. The table 70 is indexed to move the molds 60 sequentially through the stations. To create a molded glass article, a mold is provided having a mold cavity defining a container having a base at a bottom of the mold cavity where the mold cavity comprises an undercut portion that defines a recess in the mold cavity (Block 601). The undercut portion is disposed toward the bottom of the mold and is located spaced from the opening in the mold through which the molded article is removed from the mold such that the protuberance extends beyond the side of the article that is located between the protuberance and the opening 64 above the protuberance in the mold. As a result the protuberance must be removed from the mold through the narrower portion of the mold. A glob of molten glass at approximately 1100° C. is introduced to the mold 60 at Station 1 (Block 602). The plunger 61 is extended to force or jam the molten glass into the mold 60 under pressure at Station 2 (Block 603). The plunger 61 is removed from the mold 60 (Block 604) and the mold and glass container 2 are sequenced through cooling Stations 3-6.

As glass cools it shrinks slightly. The present invention takes advantage of this shrinkage by dimensioning the protuberance 40 such that the length the protuberance that extends beyond the wall portion 4a and accordingly the length L of the undercut portion 66 is selected to be approximately the same or less than the amount of shrinkage of the glass as it cools. As a result, as the glass cools the base 4 and protuberance 40 shrink to the point that the glass protuberance 40 is withdrawn from the recess 67 and the distal end of the protuberance 40 will clear the undercut area 66 when the container 2 is removed from the mold 60 (Block 605). In one embodiment the distance the protuberance 40 extends beyond wall 4a is less than 1 mm and may be approximately 0.25 mm although the absolute amount of shrinkage in linear distance will vary based on the size of the container and the amount of glass in the base 4.

To control the cooling of the molded glass container and to ensure that the base 4 cools sufficiently to obtain the desired shrinkage a plurality of cooling stations, Stations 3 through 6, are provided prior to releasing the container from the mold. The cooling stations run coolant over the mold 60 in the area adjacent to the base 4 to cool the base 4 sufficiently to cause the desired shrinkage (Block 606). The coolant may comprise air, water or other coolant blown or sprayed over and/or through the mold adjacent to at least the base 4 of the container 2. After the cooling stations the table 70 indexes the mold 60 and container 2 to Station 10 where the container 2 is removed from the mold 60 (Block 607).

Even with the appropriate cooling and shrinking, the tolerances necessary to make the protuberances work properly with the lid are very small. Because the protuberance extends for less than 1 mm and may be approximately 0.25 mm, the total dimension D (FIG. 1) of the base 4 between the distal ends of protuberances 40 must be maintained to within ±0.5 mm. Therefore, even with very small tolerances on the mold and controlling the cooling of the base, the possibility exists that the mold in the area of the undercut portion 66 may interfere slightly with the protuberance 40 when the glass container 2 is removed from the mold. Accordingly, as shown in FIG. 13, before each glass injection cycle the mold is lubricated at Stations 11 and 12 such that the in the area of the undercut portion 66 the mold is completely lubricated prior to the introduction of the molten glass at Station 1 (Block 608). The lubricant allows the protuberance 40 to slide past the undercut portion 66 even if there is a small amount of interference between the protuberance 40 and the area of the mold in the area of the undercut portion 66.

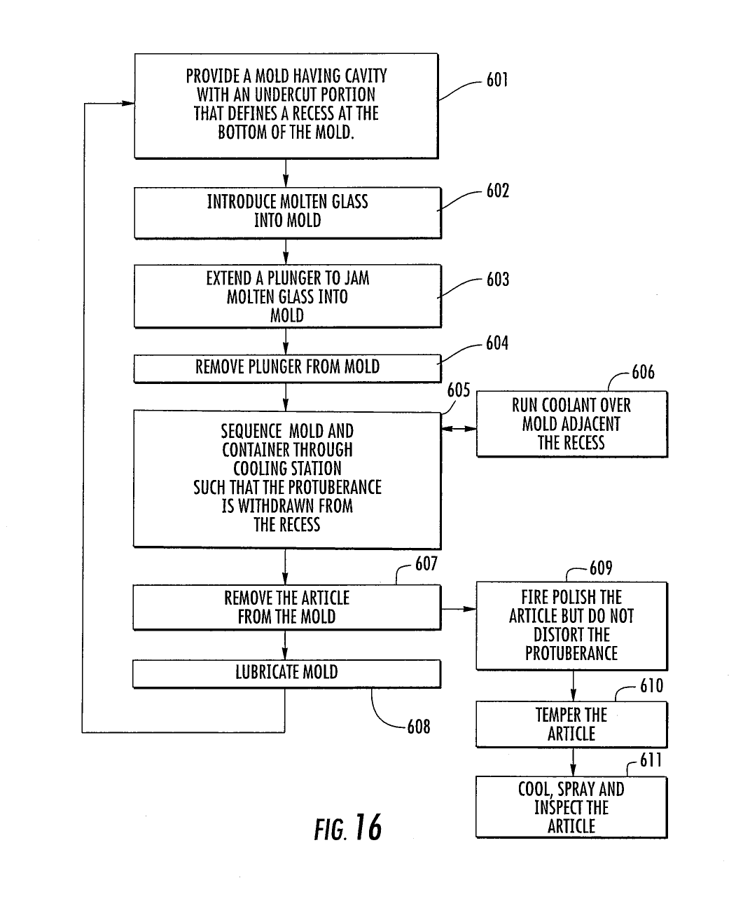

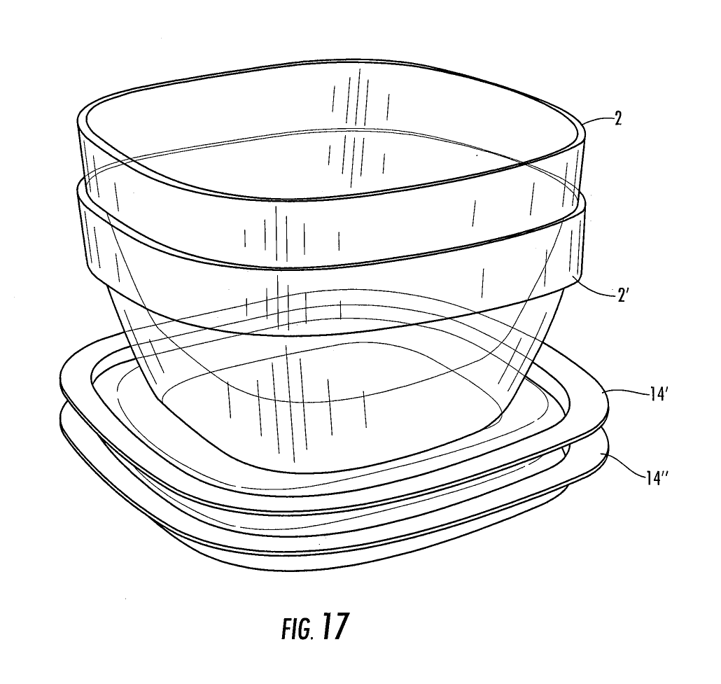

Finally, because the dimension D of the base has a small tolerance in order to be able to attach to the lids 14, a fire polishing or flame treatment step of the glass molded article to smooth the finish of the container 2 is provided such that the protuberances are not distorted during the flame treatment step. For example, as shown in FIG. 14, the flame F is directed toward the upper portions of sides 6 sides and the interior surface of the container 2 but is not directed at the base 4 so as to not distort protuberances 40 (Block 609). As a result the fire polishing step does not affect the overall dimension D of the base or the dimension of the protuberances 40.

The polished containers 2 may then be introduced to a tempering oven 72 where the glass is tempered as is known (Block 610). The heat tempered articles may then be air cooled, sprayed with a food safe spray and inspected (Block 611).

Although specific embodiments have been illustrated and described herein, those of ordinary skill in the art appreciate that any arrangement which is calculated to achieve the same purpose may be substituted for the specific embodiments shown and that the invention has other applications in other environments. This application is intended to cover any adaptations or variations of the present invention. The following claims are in no way intended to limit the scope of the invention to the specific embodiments described herein.

1. A glass container system comprising:
a glass container comprising a base defining a bottom of the container and a sidewall formed integrally with the base to define an interior space; a protuberance formed integrally with the base, the protuberance extending beyond the a side wall of the base a distance of approximately 1 mm;
a lid dimensioned such that the protuberance engages the lid such that the lid may be releasably secured to the base.

2. (canceled)

3. The system of claim 1 further comprising a plurality of protuberances.

4. The system of claim 3 wherein the plurality of protuberances are spaced about the base.

5. The system of claim 1 further comprising a second glass container, the second glass container dimensioned to nest in the glass container.

6. The system of claim 1 wherein the protuberance extends beyond the side wall a distance of approximately 0.25 mm.

7. The system of claim 1 wherein the lid comprises a lip, the lip being releasbly engageable by the protuberance such that the lid may be releasably secured to the base.

8. A glass container comprising a base defining a bottom of the container and a sidewall formed integrally with the base to define an interior space; a protuberance formed integrally with the base extending beyond the a side wall of the base a distance of approximately 1 mm, prepared by a process comprising the steps of: providing a mold having a mold cavity defining a container having a base and aside wall formed integrally with the base at a bottom of the mold cavity where
the mold cavity comprises an undercut portion that defines a recess in the mold cavity;
introducing molten glass to the mold such that the glass fills the undercut portion to create a protuberance on the base that extends beyond the side wall;
cooling the glass to cause the glass to shrink a sufficient amount that the protuberance recedes from the recess;
removing the container from the mold in a linear direction.

9. The glass container prepared by the process of claim 8 further comprising the step of lubricating the mold cavity before each step of introducing molten glass.

10. The glass container prepared by the process of claim 8 further comprising the step of flame treating the container without distorting the protuberance.

11. (canceled)

12. The glass container prepared by the process of claim 8 wherein the step of cooling comprises running coolant over the mold in the area adjacent to the base.

13. The glass container prepared by the process of claim 12 wherein the coolant comprises air.

14. The glass container prepared by the process of claim 8 wherein the step of cooling comprises cooling the interior of the container.

15. The glass container prepared by the process of claim 8 further comprising the step of tempering the glass.

16. The glass container prepared by the process of claim 8 further comprising a plurality of protuberances.

17. The glass container prepared by the process of claim 16 wherein the plurality of protuberances are spaced about the base.

18. The glass container prepared by the process of claim 8 wherein the protuberance extends beyond the side wall a distance of approximately 0.25 mm.
